(19) United States
(12) Patent Application Publication
(10) Pub. No.: US 2016/0070847 A1
(43) Pub. Date: Mar. 10, 2016

(54) PATTERN DIMENSION CALCULATION METHOD, SIMULATION APPARATUS, COMPUTER-READABLE RECORDING MEDIUM AND METHOD OF MANUFACTURING A SEMICONDUCTOR DEVICE

(71) Applicant: KABUSHIKI KAISHA TOSHIBA, Minato-ku (JP)

(72) Inventors: Takafumi TAGUCHI, Hiratsuka (JP); Takashi ICHIKAWA, Saitama (JP); Sadatoshi MURAKAMI, Yokohama (JP); Norihisa SUZUKI, Yokohama (JP)

(73) Assignee: KABUSHIKI KAISHA TOSHIBA, Minato-ku (JP)

(21) Appl. No.: 14/625,031

(22) Filed: Feb. 18, 2015

Related U.S. Application Data
(60) Provisional application No. 62/047,902, filed on Sep. 9, 2014.

(51) Int. Cl. G06F 17/50

(52) U.S. Cl. CPC G06F 17/5081

(57) ABSTRACT

According to an embodiment, a pattern dimension calculation method includes setting a reference point on a first circuit pattern, calculating, as a size of area of an opposing pattern, a size of area of a range corresponding to the reference point of a second circuit pattern opposite to the reference point, and calculating a dimension of the first circuit pattern in accordance with the size of area of the opposing pattern.

### CROSS REFERENCE TO RELATED APPLICATIONS

This application is based upon and claims the benefit of priority from the prior U.S. Provisional Patent Application No. 62/047,902, filed on Sep. 9, 2014, the entire contents of which are incorporated herein by reference.

### FIELD

Embodiments described herein relate generally to a pattern dimension calculation method, a simulation apparatus, a computer-readable recording medium and a method of manufacturing a semiconductor device.

### BACKGROUND

In a semiconductor device in recent years, it is becoming difficult to process a film to be processed in accordance with a design pattern because the size of the semiconductor device is reduced. For this reason, it is desired to highly accurately predict the dimension after the pattern of the film to be processed has been processed.

### BRIEF DESCRIPTION OF THE DRAWINGS

FIGS. 1A, 1B and 1C are figures for explaining a post-process dimension calculation processing using an opening angle according to a first embodiment.

FIG. 2 is a flowchart illustrating a manufacturing method of a photo mask according to the first embodiment.

FIGS. 3A, 3B, 3C and 3D are figures for explaining closure of a groove formed in a film to be processed.

FIG. 4 is a view illustrating a shape of a processed pattern calculated according to a post-process dimension prediction method using the opening angle.

FIGS. 5A, 5B and 5C are figures for explaining a mechanism for closing the groove.

FIGS. 6A and 6B are figures for explaining the post-process dimension calculation processing using a size of area of an opposing pattern according to the first embodiment.

FIGS. 7A and 7B are figures for explaining the post-process dimension calculation processing using the size of area of the opposing pattern according to the first embodiment.

FIG. 8 is a figure illustrating a dimension of the processed pattern calculated using the size of area of the opposing pattern and the opening angle.

FIG. 9 is a figure illustrating a relationship between a degree of an effect and a distance according to a second embodiment.

FIGS. 10A and 10B are figures for explaining the post-process dimension calculation processing using the size of area of the opposing pattern according to the second embodiment.

FIGS. 11A and 11B are figures illustrating another example for explaining the post-process dimension calculation processing using the size of area of the opposing pattern according to the second embodiment.

FIG. 12 is a block diagram of a schematic configuration of a simulation apparatus according to a third embodiment.

### DETAILED DESCRIPTION

According to an embodiment, a pattern dimension calculation method includes setting a reference point on a first circuit pattern, calculating, as a size of area of an opposing pattern, a size of area of a range corresponding to the reference point of a second circuit pattern opposite to the reference point, and calculating a dimension of the first circuit pattern in accordance with the size of area of the opposing pattern.

Hereinafter, embodiments of the present invention will be described with reference to the drawings. The embodiments do not limit the present invention.

### First Embodiment

When a resist pattern corresponding to a design pattern and the like is transferred onto a wafer as it is, a processed pattern having a pattern shape (pattern of an insulation film) that is different from the pattern shape of the resist pattern is formed on a wafer. For example, the following phenomena may occur, e.g., a line length of the processed pattern becomes shorter, a line length of the processed pattern becomes longer, and a corner becomes rounder. One of the reasons why such phenomena (dimension conversion difference) occur is a process conversion difference caused by, e.g., the effect of etching (for example, pattern dependency of etching speed and the like).

In order to achieve desired electrical characteristics as a semiconductor device, it is necessary to suppress occurrence of malfunction due to a break and a bridge of a pattern. Therefore, it is necessary to realize a dimension and a shape according to the design pattern on the wafer. Accordingly, it is necessary to predict, in advance, the dimension of the pattern after the process, and correct the pattern shape on the photo mask used in a lithography step in accordance with the prediction result.

For example, the dimension precision of a pattern to be formed is greatly affected by the layout environment of another pattern arranged around the pattern to be formed. More specifically, as the space length between patterns increases, the dimension conversion difference also increases. However, the space length and the dimension conversion difference may not be necessarily in a proportional relationship. The shape of the actual pattern is not limited to a linear pattern shape. Therefore, when the shape of the pattern becomes non-linear, there is an error in the post-process dimension.

As a result of consideration, the inventors of the present application have found that when an opening angle in a portion subjected to the post-process dimension prediction (hereinafter, this portion is referred to as a dimension prediction point (reference point)) is derived on the basis of the design pattern data, and the post-process dimension is predicted by analyzing the correlation relationship between opening angle and the actual measured value of the post-process dimension, then, the precision of the post-process dimension prediction can be improved regardless of the shape of the pattern.

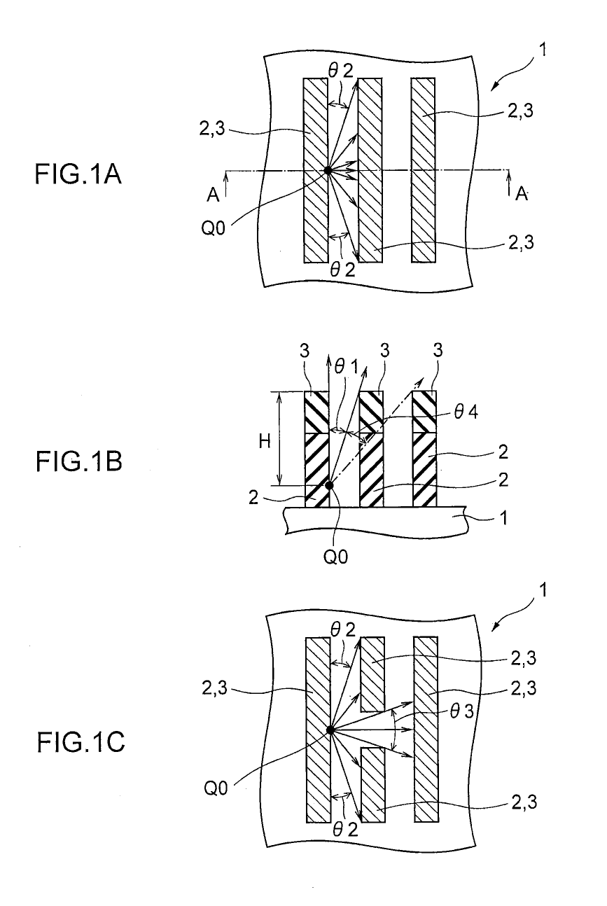

FIGS. 1A, 1B and 1C are figures for explaining the post-process dimension calculation processing (pattern dimension calculation processing) using the opening angle according to the first embodiment. FIG. 1A is a top view illustrating a wafer 1 on which a circuit pattern such as a semiconductor integrated circuit is formed. FIG. 1B is a longitudinal sectional view taken along A-A of FIG. 1A. FIG. 1C is a top view illustrating the wafer 1 provided with a not-continuous pattern.

In this case, as shown in FIGS. 1A, 1B and 1C, for example, an insulation film formed on the wafer 1 is etched using a resist pattern 3 as a mask, and accordingly, a processed pattern (circuit pattern) 2 is formed.

As shown in FIG. 1B, the position of the insulation film which becomes the processed pattern 2 is set as a dimension prediction point Q0, and when the post-process dimension prediction is performed, the opening angle at the dimension prediction point Q0 is derived. The dimension prediction point Q0 is a position below the upper surface of the resist pattern 3 in the vertical direction (at the side of the wafer 1) by a distance H.

When the upper surface of the processed pattern 2 is the dimension prediction point Q0, the distance H is the same value as the thickness of the resist pattern 3. When the bottom surface of the pattern of the formed processed pattern 2 is the dimension prediction point Q0, the distance H is the same value as a summation of the thickness of the resist pattern 3 and the thickness of the processed pattern 2. The dimension prediction point Q0 is set, along the pattern side surface of the formed processed pattern 2, between the position at the same height as the upper surface of the processed pattern 2 and the position at the same height as the bottom surface of the processed pattern 2. An opening angle is determined for each position of the dimension prediction point Q0, and using this opening angle, the pattern shape of the processed pattern 2 is calculated for each position of the dimension prediction point Q0.

The opening angle is defined as an angle subtended by a portion of a spherical surface swept by a half line extending from the dimension prediction point Q0 as the center, in which portion the half line does not interfere with the resist pattern 3 and the processed pattern 2 in proximity. In other words, when a half line extending from the dimension prediction point Q0 is moved to draw a spherical surface about the dimension prediction point Q0 as the center, a range in which the half line can move without colliding with another pattern is the opening angle. Therefore, the opening angle is denoted as a solid angle.

Such opening angle can be derived on the basis of the design pattern data.

In this case, for the sake convenience, the opening angle will be further explained using a typical cross section of a solid body (a portion of a spherical surface) drawn as described above. The angle in the typical cross section (the range in which the half line can move) is represented as a plane angle.

For example, when the wafer 1 is seen in the cross sectional direction, the opening angle (plane angle) at the dimension prediction point Q0 is θ1 as shown in FIG. 1B. When the wafer 1 is seen in the upper surface direction, the opening angle (plane angle) at the dimension prediction point Q0 is θ2 as shown in FIG. 1A.

When there is an interrupted part in an adjacent pattern, the opening angle is larger by θ3 than θ2 when the wafer 1 is seen in the upper surface direction as shown in FIG. 1C. When there is an interrupted part in an adjacent pattern, the opening angle is larger by θ4 than θ1 when the wafer 1 is seen in the cross sectional direction as shown in FIG. 1B.

Further, the opening angle θ1 changes according to the distance (space) between processed patterns 2 at the same height as the dimension prediction point Q0 and the vertical direction position (distance H) of the dimension prediction point Q0. Accordingly, when the space length between processed patterns 2 is longer, the opening angle θ1 increases, and when the distance H decreases, the opening angle θ1 increase.

As described above, when the relationship between the space length and the opening angle θ1 is analyzed in advance for each vertical direction position (distance H) of the dimension prediction point Q0, the opening angle θ1 can be easily calculated using the distance H as a parameter.

Such opening angle affects the incident amount of incident objects (for examples, radicals and ions) at the dimension prediction point Q0 during the etching process, which may become the factor of changing the value of the post-process dimension. More specifically, when the opening angle increases, the amount of incident objects that can be incident upon the dimension prediction point Q0 is increased in accordance with the increase in the opening angle. Therefore, in accordance with the increase in the opening angle, the process conversion difference increases, and as a result, the pattern length (line length) of the processed pattern 2 is likely to become shorter.

Therefore, when the opening angle is taken into consideration in the post-process dimension prediction processing, the value of the post-process dimension reflecting the layout environment in multiple directions can be known, and therefore, regardless of the shape of the pattern, the precision of the post-process dimension prediction can be improved.

Subsequently, the post-process dimension prediction method using the opening angle will be explained.

First, the opening angle is derived as described above. At this occasion, the opening angle θ1 in a direction perpendicular to the principal plane of the wafer 1 may be a function in which the distance H is used as a variable because the space length is determined in the design. For this reason, an opening angle, which is a solid angle including the opening angle (a plane angle) θ1, can also be treated as a function θ (H) in which the distance H is used as a variable.

As a result, for example, the post-process dimension CD can be expressed in a function as shown in the following expression (1).

the post-process dimension CD=α+β×opening angle θ(H) (1)

It should be noted that α, β are coefficients, and can be determined by regression analysis method and the like. When the coefficients α, β are determined according to the regression analysis method, the method of least squares can be used. More specifically, the coefficients α, β are derived to yield the least root-mean-square of the difference between the actual measured value (experiment value) of the post-process dimension and the computation value. At this occasion, the distance H may be selected to yield the least error between the actual measured value and the computation value, and the above computation may be performed.

For example, the regression analysis method which is a type of multivariate analysis technique has been shown as the analysis method of a, 13, but the embodiment is not limited thereto. For example, the correlation relationship between the opening angle and the actual measured value of the post-process dimension is analyzed using other multivariate analysis technique, response surface methodology, and the like to make compact model, and the post-process dimension prediction may be performed under various kinds of specific conditions on the basis of the model.

On the basis of the opening angle, the value of the post-process dimension may be defined in a stepwise manner. As described above, when the post-process dimension is derived in a stepwise manner using the regression analysis method and the like, the deviation from the actual measured value (experiment value) can be reduced. Then, on the basis of the value of the post-process dimension determined in a stepwise manner, e.g., the pattern of the photo mask can be corrected and the risky points can be verified as described later.

When the dimension prediction point is set on the upper surface of the insulation film, the opening angle at the dimension prediction point is calculated, and the shape of the processed pattern 2 (the processed pattern 2 during the process) in a case where the insulation film is processed to a predetermined depth using the opening angle is predicted. Thereafter, the dimension prediction point on the upper surface of the processed pattern 2 during the process is set, and the opening angle at the dimension prediction point is calculated, and the shape of the processed pattern 2 (the processed pattern 2 during the process) in a case where the insulation film is further processed to a predetermined depth using the opening angle is predicted.

Then, until a desired process depth is obtained, the following processing is repeated, which includes setting processing of the dimension prediction point onto the processed pattern 2 during the process which has been predicted, calculation processing of the opening angle, and the shape prediction processing of the processed pattern 2 in a case where the processed pattern 2 during the process is further processed. Therefore, when the dimension prediction point is set on the processed pattern 2 during the process, the opening angle at the dimension prediction point is calculated using the shape of the processed pattern 2 during the process.

Instead of the post-process dimension, a dimension conversion difference due to etching may be calculated. The dimension conversion difference may be a shape difference (dimension difference) between the design pattern and the processed pattern 2, or may be a shape difference between the resist pattern 3 and the processed pattern 2. The dimension conversion difference is calculated on the basis of the prediction result of the post-process dimension.

The incident amount of incident objects at the dimension prediction point is derived on the basis of design data, and the correlation relationship between the incident amount and the actual measured value of the post-process dimension is analyzed, whereby the post-process dimension may be predicted. The incident amount of incident objects at the dimension prediction point depends on the type of the incident object and the opening angle. Even in this case, the precision of the post-process dimension prediction can be improved regardless of the shape of the pattern.

Subsequently, a manufacturing method of a photo mask will be explained.

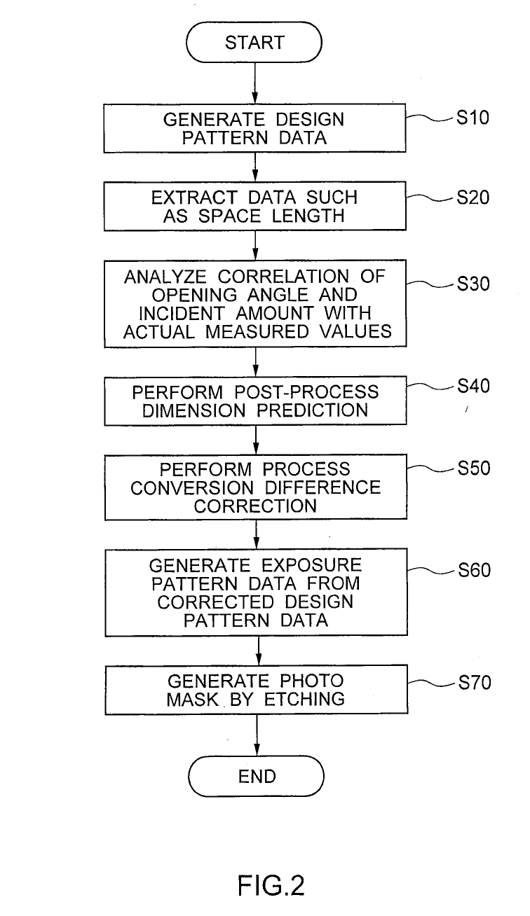

FIG. 2 is a flowchart illustrating a manufacturing method of a photo mask according to the first embodiment. Processing in steps S10 to S60 shown below is performed by a computer.

First, design pattern data (data of a pattern to be formed on a wafer) are generated (step S10).

Subsequently, data such as a space length, a line length, and the shape of the pattern are extracted from the design pattern data (step S20).

Subsequently, the opening angle, the incident amount, and the like, which have been explained above, are calculated on the basis of the extracted data, and the correlation relationship between them and the actual measured value (experiment value) of the post-process dimension measured in advance are analyzed (step S30).

Subsequently, using an expression of the post-process dimension obtained as a result of the analysis (for example, expression (1)), the values of the post-process dimension are calculated, or the values of the post-process dimension are selected from a table summarizing, in a stepwise manner, the values of the post-process dimension obtained as a result of the analysis, and thus the post-process dimension prediction is performed (step S40).

Subsequently, the process conversion difference correction is performed using the values of the post-process dimension calculated (step S50). More specifically, on the basis of the values of the post-process dimension, a verification and the like is performed to find a risky point where the processed pattern 2 becomes a malfunctioning point at a ration equal to or more than a predetermined value. When there is risky point, the pattern correction of the photo mask, the correction of the design pattern (space width and the like), the change of the dimension of the process film (insulation film), and the like are performed on the basis of the values of the post-process dimension. These corrections and changes are done by changing at least one of the exposure condition of the exposure device, the mask pattern, and the design layout. Examples of exposure conditions include the amount of exposure, illumination brightness, shape correction, opening angle of the lens (NA), exposure wavelength, lens aberration, polarization degree, and the like.

In step S50, the optical proximity effect correction may be done at the same time. An already-available technique may be applied to the optical proximity effect correction, and therefore explanation thereabout is omitted.

When the corrected design pattern data involve a portion where the design rule is not satisfied, the design pattern data are corrected, and the process conversion difference correction and the optical proximity effect correction are performed again on the corrected data.

Subsequently, the exposure pattern data are generated from the corrected design pattern data (step S60).

Subsequently, the photo mask is generated by etching process on the basis of the generated exposure pattern data (step S70).

As described above, the design pattern data are corrected using the dimension of the processed pattern 2 calculated in accordance with the post-process dimension prediction method explained above, and the photo mask is generated on the basis of the corrected design pattern.

In this manner, regardless of the shape of the pattern, the precision of the post-process dimension prediction can be improved, and therefore, the correction can be performed appropriately. For this reason, the photo mask providing a high production yield can be obtained.

Thereafter, a semiconductor device (semiconductor integrated circuit) is manufactured using the photo mask in the wafer process. More specifically, the exposure device performs exposure processing on the wafer using the photo mask, and thereafter, developing processing and etching processing are performed on the wafer. In other words, an insulation film, which is a film to be processed, is patterned by etching process using the resist pattern formed by transfer process in the lithography step as the mask material. When the semiconductor device is manufactured, the exposure processing, the developing processing, the etching processing, and the like explained above are repeated on each layer.

As described above, when the opening angle is taken into consideration, the precision of the process simulation (the post-process dimension prediction) can be improved regardless of the shape of the pattern. Therefore, the process conversion difference correction can be performed appropriately. Therefore, this can suppress degradation of electrical characteristics, a bridge, a break of the processed pattern 2 and the like, caused by the process conversion difference in the shape of the processed pattern 2.

### (Post-Process Dimension Prediction Using the Size of an Opposing Pattern)

By the way, the inventors of the present application have noticed that, even when the design pattern data are corrected using the post-process dimension prediction method using the opening angle explained above, the following issues occurs: when a groove having a high aspect ratio is formed in a film to be processed, the bottom portion of the groove is closed depending on the shape of the pattern.

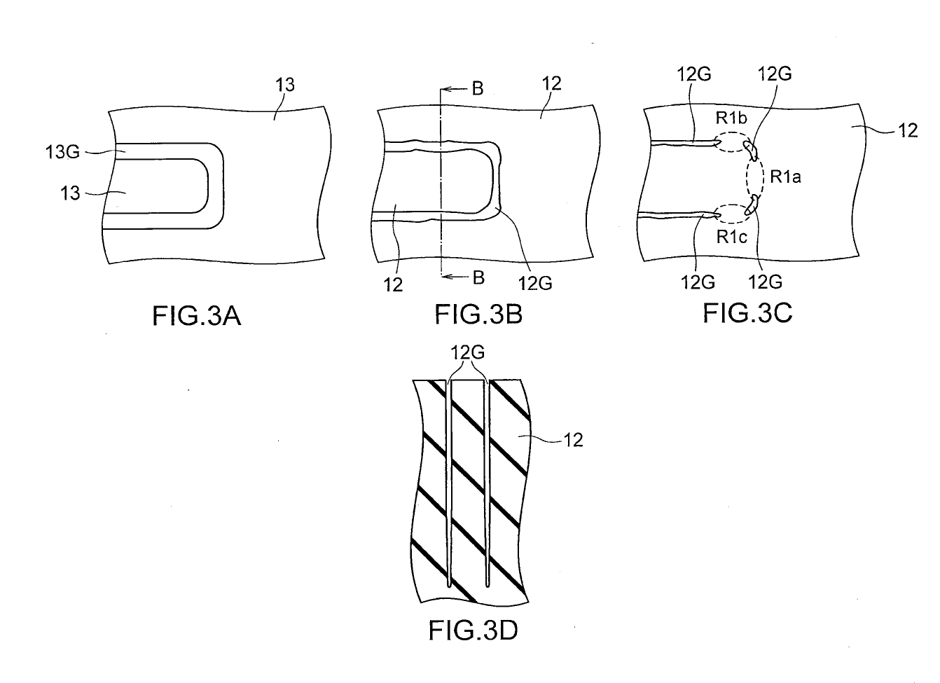

FIGS. 3A, 3B, 3C and 3D are figures for explaining closure of a groove formed in the film to be processed (insulation film).

FIG. 3A is a top view illustrating an upper surface shape of a resist pattern 13 provided on the film to be processed. A U-shaped space 13G having a substantially constant width is formed in the resist pattern 13.

FIG. 3B is a top view illustrating an upper surface shape of a film 12 to be processed, which has been etch-processed by RIE (Reactive Ion Etching) using the resist pattern 13 of FIG. 3A.

In FIG. 3B, the resist pattern 13 remaining after the etching process is removed. In the film 12 to be processed, the groove 12G having the same shape as the space 13G of the resist pattern 13 is formed. The groove 12G has a high aspect ratio, and is formed to be relatively deeply.

FIG. 3C is a cross sectional view illustrating the shape of the bottom portion side of the film 12 to be processed shown in FIG. 3B. FIG. 3C illustrates a cross sectional shape when the film 12 to be processed is cut in parallel with the upper surface of the film 12 to be processed. As shown in FIG. 3C, the groove 12G is not formed in an area R1a where a short side portion of the groove 12G is to be formed, and areas R1b, R1c where long side portions are to be formed in proximity to portions where the groove 12G is bent. More specifically, in the areas R1a to R1c, the groove 12G is closed.

FIG. 3D is a longitudinal sectional view illustrating a sectional shape taken along line B-B of the film 12 to be processed shown in FIG. 3A. As shown in FIG. 3D, in the portions where the groove 12G is not closed, the two grooves 12G reach about the same depth.

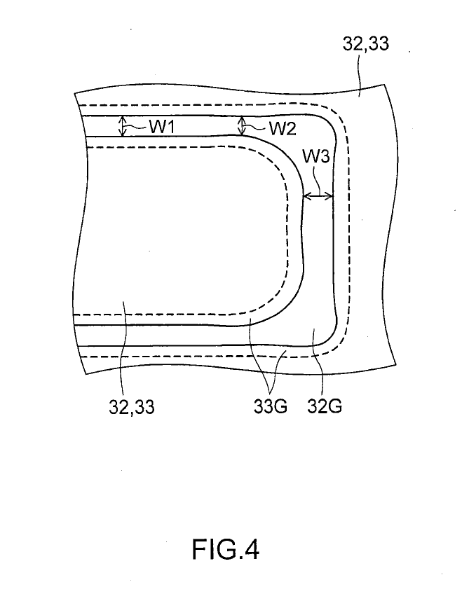

FIG. 4 is a view illustrating the shape of the processed pattern calculated according to the post-process dimension prediction method using the opening angle. FIG. 4 is a figure illustrating the upper surface shape of the resist pattern 33 and the upper surface shape of the processed pattern 32 calculated. The upper surface shape of the resist pattern 33 corresponds to the upper surface shape of the resist pattern 13 of FIG. 3A. Therefore, in FIG. 3C and FIG. 4, a position in the height direction is different, but in the in-plane direction, a substantially same position is indicated. In FIG. 4, the edge of the resist pattern 33 is indicated by a broken line, and the edge of the processed pattern 32 is indicated by a solid line. The processed pattern 32 is calculated on the basis of the shape of the resist pattern 33 in accordance with the post-process dimension prediction method using the opening angle.

In FIG. 4, overall, the width of the groove 32G of the processed pattern 32 is calculated as being narrower than the width of the space 33G of the resist pattern 33. However, the width W3 of the short side portion of the groove 32G corresponding to the area R1a where the groove 12G is closed in FIG. 3C is calculated as being thicker than the width W1 of the long side portions of the groove 32G corresponding to the portions where the groove 12G is not closed in FIG. 3C. More specifically, in this portion, the precision of the prediction of the processed pattern 32 is low. It should be noted that the width W2 is calculated as being narrower than the width W1.

Therefore, even though the design pattern data are corrected based on this processed pattern 32, it may be almost impossible to prevent the groove 12G from being closed.

The inventors of the present application have repeatedly performed experiments to find the reason why such closure of the groove occurs, and has conceived of the following mechanism.

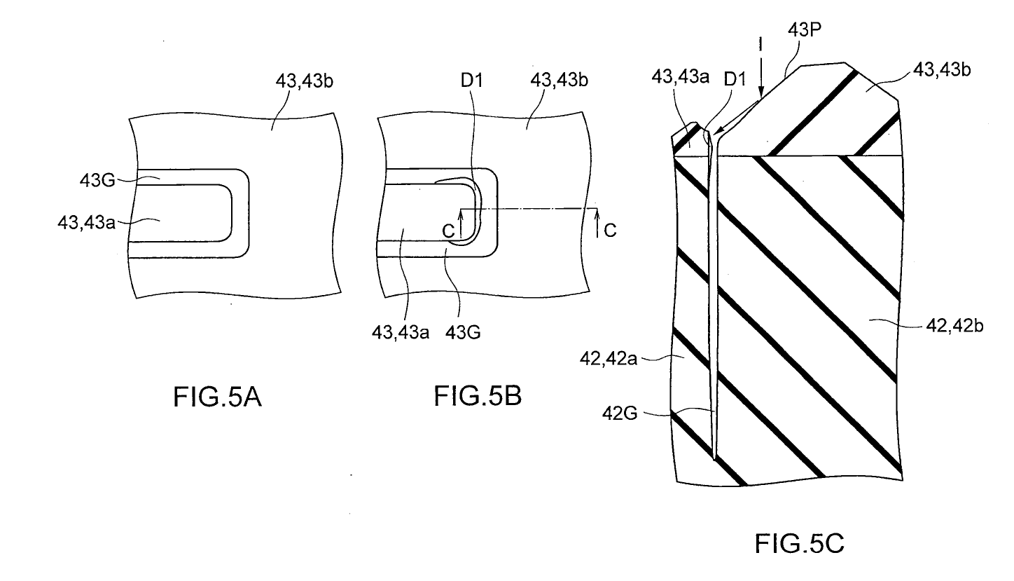

FIGS. 5A, 5B and 5C are figures for explaining a mechanism for closing the groove. FIG. 5A is a top view illustrating the upper surface shape of the resist pattern 43 before the etching process provided on the film to be processed. The resist pattern 43 includes a linear inner-side pattern portion 43a and an outer-side pattern portion 43b surrounding the inner-side pattern portion 43a with the space 43G interposed therebetween.

FIG. 5B is a top view illustrating the upper surface shape of the resist pattern 43 after the etching process. As a result of the etching, an inner-side pattern portion 42a of the processed pattern 42 is formed below the inner-side pattern portion 43a of the resist pattern 43, and an outer-side pattern portion 42b of the processed pattern 42 is formed below the outer-side pattern portion 43b of the resist pattern 43. In FIG. 5B, a deposit D1 attaches to the side surface of the inner-side pattern portion 43a of the resist pattern 43.

FIG. 5C is a longitudinal sectional view illustrating a cross sectional shape taken along line C-C of FIG. 5B. The height of the outer-side pattern portion 43b of the resist pattern 43 is higher than the inner-side pattern portion 43a, and includes an inclination surface 43P. Before the etching process, the height of the outer-side pattern portion 43b and the height of the inner-side pattern portion 43a are substantially the same. Therefore, the difference in the height and the shape caused by the etching as described above is considered to be caused because the size of area of the outer-side pattern portion 43b is larger than the size of area of the inner-side pattern portion 43a in the top view of FIG. 5A. The inventors of the present application thought that during the etching, a product generated from an incident object I such as ion which is incident upon the inclination surface 43P reattaches to the side surface of the inner-side pattern portion 43a of the resist pattern 43 and the inner-side pattern portion 42a of the processed pattern 42 via the path indicated by an arrow in FIG. 5C (re-deposition occurs).

Accordingly, the inventors of the present application thought that the incident object I is shielded by the inner-side pattern portion 43a of the resist pattern 43 and the inner-side pattern portion 42a of the processed pattern 42 extending by the amount equivalent to the deposit D1 with respect to the design pattern data, and in the deep portion, the groove 42G becomes narrower than the design pattern data and becomes closed.

Therefore, as a result of consideration, the inventors of the present application have found that the precision of the post-process dimension prediction can be further improved by performing not only the post-process dimension prediction using the opening angle but also deriving the size of area of the opposing pattern of the opposing circuit pattern (second circuit pattern) opposite to the dimension prediction point on the basis of the design pattern data, and analyzing the correlation relationship between the size of area of the opposing pattern and the actual measured value of the post-process dimension to predict the post-process dimension.

Hereinafter, the post-process dimension prediction method using the size of area of the opposing pattern will be explained. In this case, for example, explained below is a case where an insulation film (a film to be processed) formed on a wafer (substrate), not shown, is etched using a resist pattern (mask material) 53 as a mask, and accordingly, a processed pattern (first circuit pattern) 52 is formed.

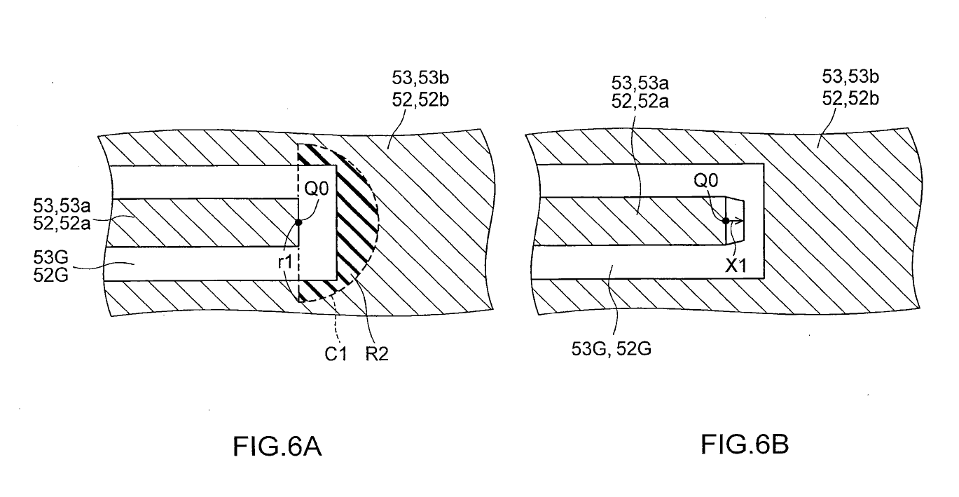

FIGS. 6A and 6B are figures for explaining the post-process dimension calculation processing (pattern dimension calculation processing) using the size of area of the opposing pattern according to the first embodiment. FIG. 6A is a top view illustrating the upper surface shape of the resist pattern 53 and the processed pattern 52 for which the post-process dimension calculation processing is performed. FIG. 6B is a top view illustrating the upper surface shape of the resist pattern 53 and the processed pattern 52 after the post-process dimension calculation processing. In this case, the pattern shape of the upper surface of the resist pattern 53 and the pattern shape of the upper surface of the processed pattern 52 are substantially the same.

First, as shown in FIG. 6A, a dimension prediction point Q0 is set on the processed pattern 52. In this case, the dimension prediction point Q0 is set on the short side of the linear inner-side pattern portion 52a.

Subsequently, the size of area in a range R2 corresponding to the dimension prediction point Q0 of the outer-side pattern portion (opposing circuit pattern) 52b which is opposite to the dimension prediction point Q0 with the groove 52G interposed therebetween is calculated as the size of area of the opposing pattern.

In this case, the range R2 corresponding to the dimension prediction point Q0 is a range in a sector having a predetermined radius r1 with the dimension prediction point Q0 being the center. The two straight line portions of the sector overlap the edge where the dimension prediction point Q0 of the inner-side pattern portion 52a is set. In the example as shown in the figure, the edge where the dimension prediction point Q0 is set is the straight line, and therefore, the range R2 is a range in a half circle C1. The straight line portion of the half circle C1 overlaps the edge of the inner-side pattern portion 52a where the dimension prediction point Q0 is set. More specifically, the half circle C1 is arranged so as not to overlap the inner-side pattern portion 52a where the dimension prediction point Q0 is set.

For example, when the dimension prediction point Q0 is set at the corner of the inner-side pattern portion 52a, the sector is arranged so as not to overlap the inner-side pattern portion 52a, and the central angle thereof is about 270 degrees.

The radius r1 of the half circle C1 is preferably more than a summation of the minimum line length of the processed pattern 52 and the minimum space length between the processed patterns 52, and is preferably equal to or less than the optical radius (for example, about 1 μm) which is a calculation area for a single calculation in the optical proximity effect correction. As described above, the optical proximity effect correction is performed in step S50 of the flowchart of FIG. 2. In a case where the radius r1 of the half circle C1 is equal to or less than the summation of the minimum line length and the minimum space length and in a case where the radius r1 of the half circle C1 is more than the optical radius, the difference in the size of area of the opposing pattern according to the dimension prediction point Q0 is decreased, and therefore, the calculation precision of the dimension is reduced.

In the plane including the dimension prediction point Q0, the size of area of the opposing pattern is calculated. This plane is substantially parallel with the surface of the wafer where the processed pattern 52 is provided.

The size of area of the opposing pattern may be calculated using the pattern shape of the upper surface of the resist pattern 53. More specifically, the size of area of the opposing pattern may be calculated on the basis of the shape of the resist pattern 53 provided as the upper layer of the processed pattern 52 and serving as the mask when the processed pattern 52 is processed.

Subsequently, the dimension of the processed pattern 52 is calculated according to the size of area of the opposing pattern. More specifically, the dimension of the processed pattern 52 is calculated on the basis of the correlation relationship of the size of area of the opposing pattern and the actual measured value of the dimension of the processed pattern 52. On the basis of such correlation relationship, for example, the amount of increase of the dimension of the processed pattern 52 (dimension conversion difference) X can be expressed by a function as shown in the following expression (2).

The amount of increase X=A+B×the size of area of the opposing pattern S (2)

More specifically, the larger the size of area of the opposing pattern, the larger the calculated dimension of the processed pattern 52 extends past the dimension prediction point Q0 toward the opposing circuit pattern. The amount of increase X1 of the dimension of the processed pattern 52 is proportional to the size of area of the opposing pattern.

A and B in the expression (2) are coefficients, and can be determined according to, e.g., the regression analysis method like the above opening angle.

As described above, as shown in FIG. 6B, the dimension of the inner-side pattern portion 52a of the processed pattern 52 is calculated so that the dimension of the inner-side pattern portion 52a of the processed pattern 52 is larger by the amount of increase X1 at the outer-side pattern portion (opposing circuit pattern) 52b with respect to the dimension prediction point Q0.

Thereafter, the dimension prediction point Q0 is moved along the edge of the inner-side pattern portion 52a of the processed pattern 52. Then, for each dimension prediction point Q0, the size of area of the opposing pattern is calculated, and according to the size of area of the opposing pattern, the dimension of the inner-side pattern portion 52a of the processed pattern 52 is calculated.

For each dimension prediction point Q0, the above opening angle is calculated, and the post-process dimension prediction using the opening angle is performed. Then, for each dimension prediction point Q0, the amount of increase X of the dimension calculated by the post-process dimension prediction using the size of area of the opposing pattern and the dimension conversion difference calculated by the post-process dimension prediction using the opening angle are added.

Subsequently, unlike the example of FIGS. 6A and 6B, a case where the dimension prediction point Q0 is set on the outer-side pattern portion 53b will be explained.

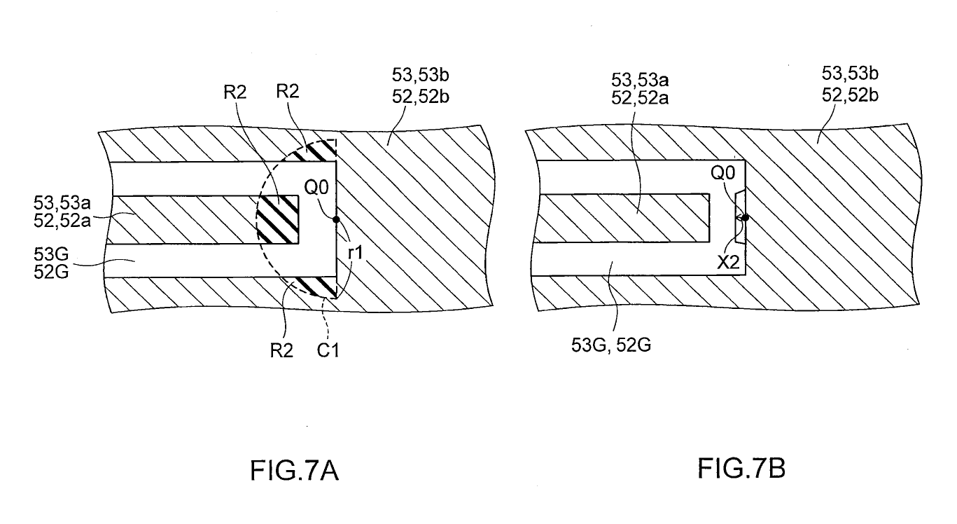

FIGS. 7A and 7B are figures for explaining the post-process dimension calculation processing using the size of area of the opposing pattern according to the first embodiment.

FIG. 7A corresponds to FIG. 6A. FIG. 7B corresponds to FIG. 6B.

First, as shown in FIG. 7A, the dimension prediction point Q0 is set on the short side of the outer-side pattern portion 52b which is opposite to the short side of the inner-side pattern portion 52a

Subsequently, the size of area of the range R2 of the half circle C1 with its center being the dimension prediction point Q0 of the inner-side pattern portion (opposing circuit pattern) 52a opposite to the dimension prediction point Q0 is calculated as the size of area of the opposing pattern.

Although only the size of area of the range R2 of the half circle C1 of the inner-side pattern portion 52a may be calculated, the size of area of the range R2 of the half circle C1 of the outer-side pattern portion 52b may be calculated, and the total summation of the sizes of these areas may be adopted as the size of area of the opposing pattern. Re-deposition is considered to occur also from the range R2 of the half circle C1 of the outer-side pattern portion 52b, and therefore, when the calculation is performed in this manner, the post-process dimension can be predicted with a higher degree of precision.

Subsequently, using the expression (2) explained above, the dimension of the outer-side pattern portion 52b is calculated in accordance with the size of area of the opposing pattern. In the example of FIGS. 7A and 7B, the size of area of the opposing pattern is less than that of the example of FIGS. 6A and 6B, and therefore, the amount of increase X2 of the dimension of the outer-side pattern portion 52b is calculated so that the amount of increase X2 of the dimension of the outer-side pattern portion 52b is less than the amount of increase X1 of FIGS. 6A and 6B.

As described above, as shown in FIG. 7B, the dimension of the outer-side pattern portion 52b of the processed pattern 52 is calculated so that the dimension of the outer-side pattern portion 52b of the processed pattern 52 is larger by the amount of increase X2 at the inner-side pattern portion (opposing circuit pattern) 52a with respect to the dimension prediction point Q0.

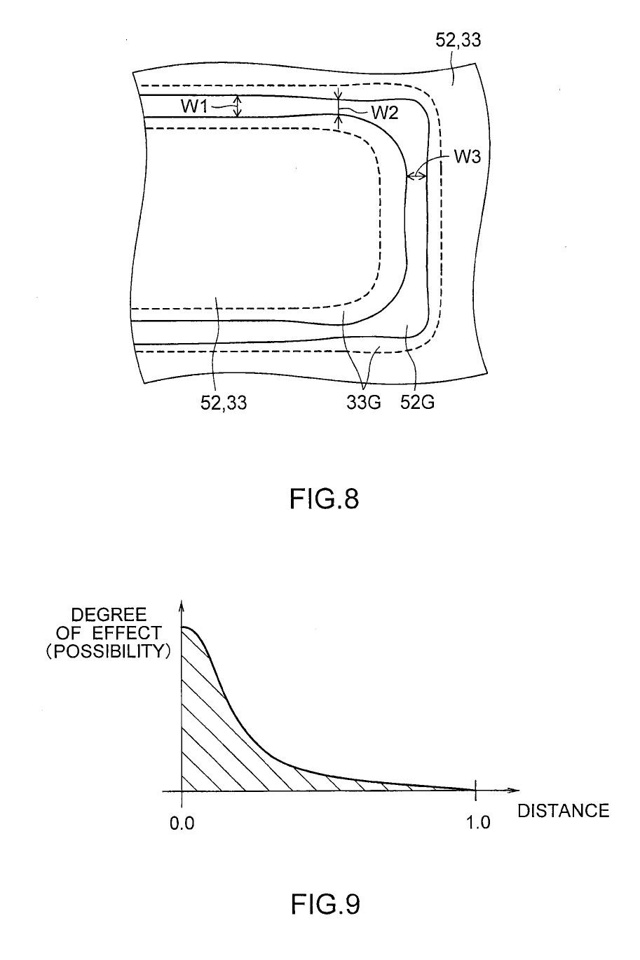

FIG. 8 is a figure illustrating the dimension of the processed pattern 52 calculated using the size of area of the opposing pattern and the opening angle. The dimension of the processed pattern 52 is calculated on the basis of the shape of the resist pattern 33 as shown in FIG. 4.

As shown in FIG. 8, the width W3 of the short side portion of the groove 52G of the processed pattern 52 is calculated to be narrower than the width W1 of the long side portion of the groove 52G. Therefore, this is a result closer to the shape actually formed as shown in FIG. 3C than the case of the processed pattern 32 calculated using the opening angle as shown in FIG. 4. More specifically, the prediction precision is improved. It should be noted that the width W2 is calculated to be narrower than the width W3.

Therefore, the design pattern data are corrected on the basis of the processed pattern 52, so that the groove can be prevented from being closed.

As described above, according to the present embodiment, the dimension of the processed pattern 52 is calculated according to the size of area of the opposing pattern, and therefore, the dimension of the processed pattern 52 reflecting the re-deposition caused by the opposing circuit pattern can be obtained. More specifically, the post-process dimension can be predicted with a higher degree of precision.

Therefore, since the precision of the process simulation (the post-process dimension prediction) can be improved regardless of the shape of the pattern, the process conversion difference correction can be performed appropriately. This can suppress the degradation of the electrical characteristics caused by the process conversion difference in the shape of the processed pattern 52, suppress the closure of the groove formed in the processed pattern 52, and suppress a bridge and a break of the processed pattern 52, and the like. As a result, the quality and the productivity of the semiconductor device can be improved. In addition, the risky point and the like can be extracted appropriately, and therefore, the verification precision of the design data can be improved.

In the present embodiment, an example where the post-process dimension prediction using the size of area of the opposing pattern and the post-process dimension prediction using the opening angle are used together has been explained. However, the embodiment is not limited thereto. Alternatively, the post-process dimension prediction using the size of area of the opposing pattern may be performed independently.

The volume of the range corresponding to the dimension prediction point Q0 of the opposing circuit pattern which is opposite to the dimension prediction point Q0 may be calculated as an opposing pattern volume, and the dimension of the processed pattern 52 may be calculated according to the opposing pattern volume. In this case, the range corresponding to the dimension prediction point Q0 is not particularly limited. The range corresponding to the dimension prediction point Q0 may be a range in a half circle pillar of which bottom surface is the half circle C1 of the radius r1, the center of the half circle C1 being the dimension prediction point Q0. Therefore, the dimension of the processed pattern 52 can be calculated reflecting the three-dimensional shape of the resist pattern 53, and therefore, the prediction precision can be further improved.

In the present embodiment, a case where the processed pattern 52 is a pattern of line and space has been explained. Alternatively, the processed pattern 52 may be a pattern of a contact hole and the like.

The post-process dimension prediction method and the manufacturing method of the photo mask can be widely applied to manufacturing of electronic components using photolithography such as forming of a pattern in manufacturing of a liquid crystal display device (for example, manufacturing of a color filter and an array substrate).

### Second Embodiment

The second embodiment is different from the first embodiment in that the dimension of a processed pattern is calculated in view of a distance from a dimension prediction point to an opposing circuit pattern.

According to the mechanism of re-deposition explained in the first embodiment, the product generated by the incident object I is less likely to re-attach when the distance from the dimension prediction point Q0 to the opposing circuit pattern is longer, and accordingly, the amount of increase X of the dimension at the dimension prediction point Q0 is considered to decrease.

Therefore, in the second embodiment, the dimension of the processed pattern is calculated in such a manner that, the longer the distance from the dimension prediction point Q0 to the opposing circuit pattern, the smaller the degree of the effect caused by the size of area of the opposing pattern on the dimension of the processed pattern becomes. More specifically, even if the size of area of the opposing pattern is constant, the dimension of the processed pattern is calculated such that the dimension of the processed pattern is smaller as the distance is longer.

The degree of the effect is calculated on the basis of the correlation relationship between the distance from the dimension prediction point Q0 to the opposing circuit pattern and the actual measured value of the amount of increase of the dimension of the processed pattern. More specifically, multiple patterns of which distances from the dimension prediction point Q0 to the opposing circuit pattern are different from each other are generated, and the actual measured value of the amount of increase of the dimension of the processed pattern at each distance is obtained. Then, on the basis of the obtained correlation relationship, a function representing the relationship between the distance and the degree of the effect is calculated. The distance in the function is normalized from zero to one using the radius r1 of the half circle C1. The function is normalized so that the degree of the effect becomes one when the distance is integrated in the range from zero to one. Therefore, the relationship as shown in FIG. 9 is obtained.

FIG. 9 is a figure illustrating a relationship between the degree of the effect and the distance according to the second embodiment. When the degree of the effect is considered to be a probability, this function may be considered to be a probability density function.

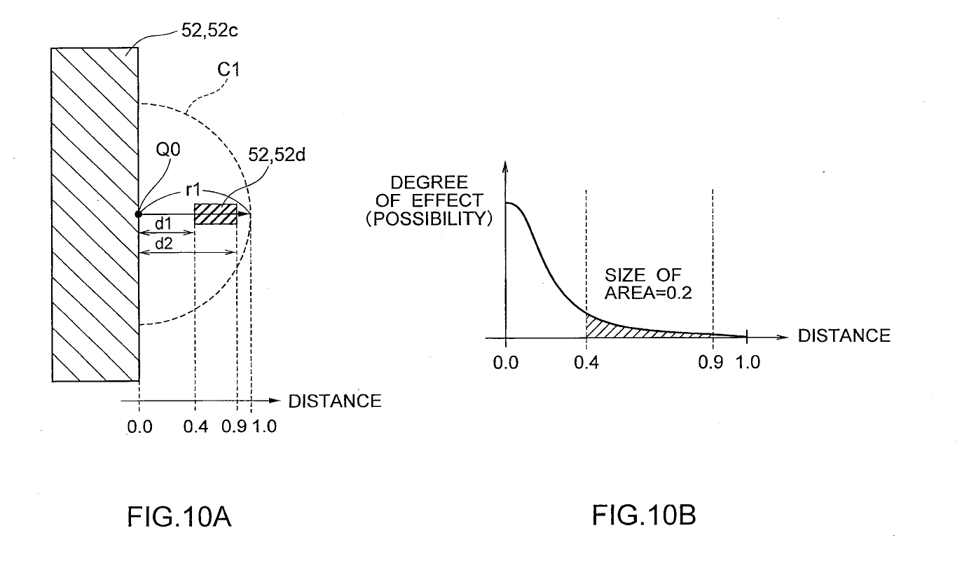

FIGS. 10A and 10B are figures for explaining the post-process dimension calculation processing using the size of area of the opposing pattern according to the second embodiment. As shown in FIG. 10A, first, the distance d1 from the dimension prediction point Q0 on the processed pattern 52c to the closer side of the opposing circuit pattern 52d and the distance d2 from the dimension prediction point Q0 to the farther side of the opposing circuit pattern 52d is normalized with the radius r1 being one and calculated. In the example as shown in the figure, the distance d1 is 0.4, and the distance d2 is 0.9

Subsequently, the degree of the effect is calculated using the function of FIG. 9. More specifically, as shown in FIG. 10B, the function of FIG. 9 is integrated in such a manner that the range between the normalized two distances d1, d2 is an integration range, and the obtained integration value is adopted as the degree of the effect. As a result, the degree of the effect is 0.2. More specifically, the ratio of the width of the opposing circuit pattern 52d with respect to the radius r1 is 0.5, but in view of the fact that it is away from the dimension prediction point Q0, the degree of the effect is 0.2.

Therefore, for example, the size of area of the opposing pattern thus calculated is multiplied by 0.2, and the dimension of the processed pattern 52 is calculated. Therefore, the dimension of the processed pattern 52 can be obtained in view of the distance from the dimension prediction point Q0 to the opposing circuit pattern.

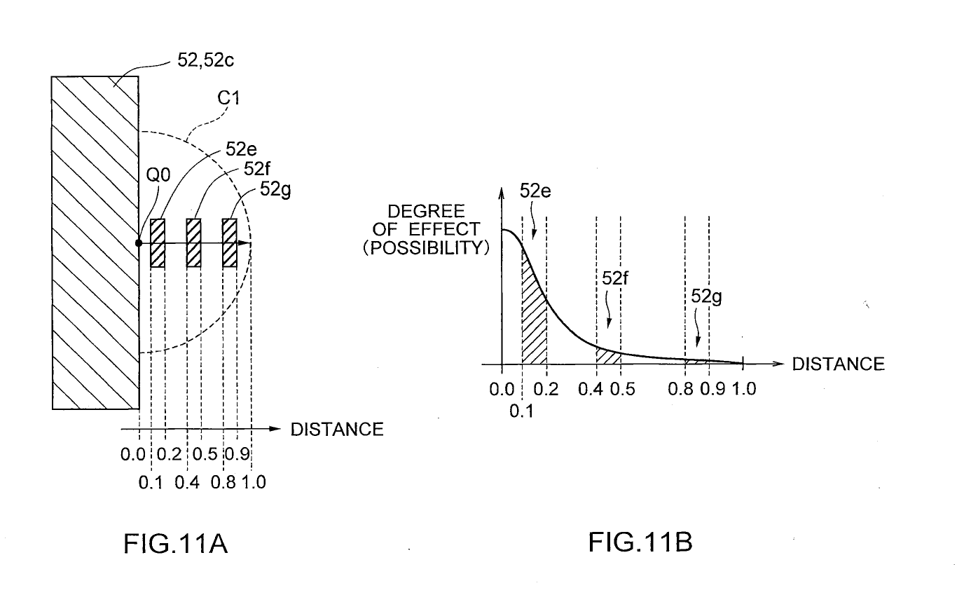

FIGS. 11A and 11B are figures illustrating another example for explaining the post-process dimension calculation processing using the size of area of the opposing pattern according to the second embodiment. In this example, three opposing circuit patterns 52e, 52f, 52g exist in the half circle C1.

As shown in FIG. 11A, the widths of the three opposing circuit patterns 52e, 52f, 52g are all 0.1, but the distances from the dimension prediction point Q0 to each of the opposing circuit patterns 52e, 52f, 52g are different. Therefore, as shown in FIG. 11B, the degree of the effect changes in accordance with the distance. More specifically, the degree of the effect of the opposing circuit pattern 52e closest to the dimension prediction point Q0 is the largest, and the degree of the effect of the opposing circuit pattern 52g farthest from the dimension prediction point Q0 is the smallest. Therefore, the dimension of the processed pattern 52 can be obtained in view of the distance from the dimension prediction point Q0 to each of the opposing circuit patterns 52e, 52f, 52g.

As described above, even when there are multiple opposing circuit patterns, the degree of the effect is normalized, and therefore, it does not become more than one.

As described above, according to the second embodiment, the dimension of the processed pattern 52 is calculated in view of not only the size of area of the opposing pattern but also the distance from the dimension prediction point Q0 to the opposing circuit pattern, and, therefore, the precision of the post-process dimension can be predicted with a higher degree of precision than the first embodiment.

### Third Embodiment

The third embodiment relates to a simulation apparatus in which the pattern dimension calculation method according to the first or second embodiment is performed.

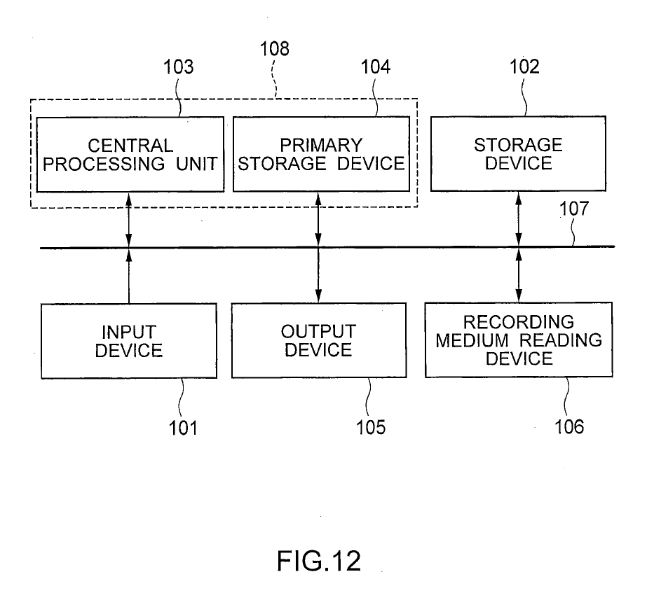

FIG. 12 is a block diagram of the schematic configuration of the simulation apparatus according to the third embodiment. The simulation apparatus includes an input device 101, a storage device 102, a central processing unit (CPU) 103, a primary storage device (memory) 104, an output device 105, a recording medium reading device 106, and a bus line 107.

The input device 101 is a user interface such as a keyboard or a mouse, and inputs the simulation condition (such as parameters required to calculate the dimension of the processed pattern).

The storage device 102 is, for example, a hard disk device and stores the input simulation condition, and a simulation program to perform the pattern dimension calculation method according to the first or second embodiment.

The central processing unit 103 and the primary storage device 104 function as an arithmetic device 108. The arithmetic device 108 performs the pattern dimension calculation method according to the first or second embodiment according to the simulation program and simulation condition stored in the storage device 102.

The output device 105 is, for example, a display or a printer, and outputs the post-process dimension obtained from the calculation in the arithmetic device 108.

The recording medium reading device 106 reads the data from a recording medium. The devices 101 to 106 are connected to each other through the bus line 107.

The simulation apparatus can provide the effect according to the first or second embodiment. In other words, the post-process dimension can be predicted with a higher degree of precision.

Note that the pattern dimension calculation method according to the first or second embodiment can be performed by reading the simulation program that performs the pattern dimension calculation method according to the first or second embodiment from a computer-readable recording medium such as an optical medium, a magnetic medium, or a non-volatile memory using the recording medium reading device 106 after storing the simulation program in the recording medium.

Alternatively, the simulation program can be distributed through a communication lines such as the Internet (including a wireless communication). Furthermore, the simulation program can be distributed through a wired network or a wireless network such as the Internet or after being stored in a recording medium, while the simulation program is encrypted, modulated, or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern dimension calculation method comprising:
setting a reference point on a first circuit pattern;
calculating, as a size of area of an opposing pattern, a size of area of a range corresponding to the reference point of a second circuit pattern opposite to the reference point; and
calculating a dimension of the first circuit pattern in accordance with the size of area of the opposing pattern.

2. The pattern dimension calculation method according to claim 1, wherein the range corresponding to the reference point is a range of a sector having a predetermined radius with the reference point being the center.

3. The pattern dimension calculation method according to claim 2, wherein two straight line portions of the sector overlap an edge of the first circuit pattern where the reference point is set.

4. The pattern dimension calculation method according to claim 2, wherein the radius of the sector is equal to or less than an optical radius, the optical radius being an area for a single calculation in an optical proximity effect correction.

5. The pattern dimension calculation method according to claim 2, wherein the radius of the sector is more than a summation of the minimum line length of the first circuit pattern and the minimum space length between the first circuit pattern and the second circuit pattern.

6. The pattern dimension calculation method according to claim 1, wherein the size of area of the opposing pattern is calculated in a plane including the reference point.

7. The pattern dimension calculation method according to claim 6, wherein the plane is in parallel with a surface of a substrate where the first circuit pattern is provided.

8. The pattern dimension calculation method according to claim 1, wherein the dimension of the first circuit pattern is calculated on the basis of a correlation relationship between the size of area of the opposing pattern and an actual measured value of the dimension of the first circuit pattern.

9. The pattern dimension calculation method according to claim 1, wherein the larger the size of area of the opposing pattern, the larger the calculated dimension of the first circuit pattern extends past the reference point toward the second circuit pattern.

10. The pattern dimension calculation method according to claim 9, wherein the amount of increase in the dimension of the first circuit pattern is proportional to the size of area of the opposing pattern.

11. The pattern dimension calculation method according to claim 1, wherein the size of area of the opposing pattern is calculated on the basis of a shape of a mask material provided as an upper layer of the first circuit pattern, the mask material serving as a mask when the first circuit pattern is processed.

12. The pattern dimension calculation method according to claim 1, wherein the dimension of the first circuit pattern is calculated in such a manner that, the longer the distance from the reference point to the second circuit pattern, the smaller the degree of the effect caused by the size of area of the opposing pattern on the dimension of the first circuit pattern becomes.

13. The pattern dimension calculation method according to claim 12, wherein the degree of the effect is calculated on the basis of a correlation relationship between the distance from the reference point to the second circuit pattern and an actual measured value of the amount of increase of the dimension of the first circuit pattern.

14. The pattern dimension calculation method according to claim 13, wherein a function indicating relationship between the distance and the degree of the effect is calculated on the basis of a correlation relationship between the distance from the reference point to the second circuit pattern and an actual measured value of the amount of increase of the dimension of the first circuit pattern,
the distance in the function is normalized to be zero to one,
the function is normalized so that when the distance is integrated in a range from zero to one, the degree of the effect becomes one, and
the degree of the effect is calculated using the function.

15. The pattern dimension calculation method according to claim 1, wherein the reference point is moved along an edge of the first circuit pattern, and
for each of the reference points, the size of area of the opposing pattern is calculated, and the dimension of the first circuit pattern is calculated in accordance with the size of area of the opposing pattern.

16. The pattern dimension calculation method according to claim 1, wherein an opening angle from the reference point to a mask material is calculated, the mask material being provided as an upper layer of the first circuit pattern, and the mask material serving as a mask when the first circuit pattern is processed, and
the dimension of the first circuit pattern is calculated in accordance with the size of area of the opposing pattern and the opening angle.

17. The pattern dimension calculation method according to claim 16, wherein the opening angle is calculated using the distance from the reference point to the second circuit pattern and a dimension in a thickness direction of the first circuit pattern where the reference point is set.

18. A simulation apparatus comprising:
an input device configured to input a simulation condition;
a storage device configured to store the simulation condition and a simulation program;
an arithmetic device configured to set a reference point on a first circuit pattern, to calculate, as a size of area of an opposing pattern, a size of area of a range corresponding to the reference point of a second circuit pattern opposite to the reference point, and to calculate a dimension of the first circuit pattern in accordance with the size of area of the opposing pattern, according to the simulation program and the simulation condition stored in the storage device; and
an output device configured to output the dimension of the first circuit pattern obtained from calculations in the arithmetic device.

19. A computer-readable recording medium storing a program for causing a computer to perform the pattern dimension calculation method according to claim 1.

20. A method of manufacturing a semiconductor device comprising:
correcting design pattern data using the dimension of the first circuit pattern calculated according to the pattern dimension calculation method of claim 1;
making a photo mask based on the corrected design pattern data; and
exposing a semiconductor substrate using the photo mask.
